(19) United States
(12) Patent Application Publication
(10) Pub. No.: US 2009/0207741 A1
(43) Pub. Date: Aug. 20, 2009

(54) Network Subscriber Baseline Analyzer and Generator

(76) Inventor: Shusaku TAKAHASHI, Tokyo (JP)

Correspondence Address: SINORICA, LLC, 2275 Research Blvd., Suite 500, ROCKVILLE, MD, 20850, US

(21) Appl. No.: 12/033,357

(22) Filed: Feb. 19, 2008

(51) Int. Cl. G01R 31/08

(52) U.S. Cl. 370/242

(57) ABSTRACT

The current application comprises four major processors for determining network abnormalities. The major difference between the current invention and all other existing systems that are being used by the network operators is that the current invention detects abnormalities by comparing with a baseline statistical model. This baseline model represents typical network traffic characteristics. When a traffic characteristic exceeds or falls outside of the baseline model, an abnormality is identified.

### FIELD OF INVENTION

This invention relates to detecting abnormalities due to failure of network elements or unexpected surge of communication traffic on a network. A baseline model of the communication network traffic is first established by sampling of real traffic data among various geographical area where each area carries different traffic model. Live traffic data on the network are continuously collected for comparing with the baseline model to identify any abnormality.

### SUMMARY OF THE INVENTION

This invention is to detect network abnormalities and failures so that the operator may take necessary measurements to correct or prevent possible performance degradations. Any abnormality or failure on the network may be caused by various reasons including hardware or software failures. Certain performance or traffic abnormalities are temporary and may not be a concern through time changes. For a residential area, the telecommunication traffic, either wireless or wireline, should be higher during the non-business hours. For a business or office area, the communication traffic should be higher during the business hours unless it's a holiday. Assuming a special event is being held in a residential area during the normal business hours, the communication traffic surges and shows abnormalities for that particular time and area.

Based on the real life communication traffic model, this invention creates a baseline model (BLM) representing each traffic characteristic for different wireless coverage areas. The BLM is first created by sampling real traffic data from various coverage areas and applied to unique modeling logic. This BLM shows normal characteristic of each coverage area assuming there are no hardware, software, or unexpected communication traffic.

After the BLM is established for different coverage area, for daily operations, the communication traffic data are collected at a predetermined time period. The collected traffic data are then statistically analyzed to compare with the BLM in order to identify any abnormality by using the current invention. The operator may then determine if the abnormality is an issue to be investigated or simply a special occurrence that can be ignored.

The telecommunication industry has been implementing various methods to identify network failures or abnormalities. All of the methods that have been implementing are based on detections of either hardware or software failures. Occasionally, operators may rely on subscribers' report to realize network traffic abnormalities. These failures and abnormalities are only to be detected when or after it would occur. It does not offer a statistical analysis that shows abnormalities which may not arise due to network element failures. The current invention allows a pre-defined threshold when real traffic data are compared with the BLM. Any traffic characteristic shown within the pre-defined threshold is considered as an allowance. When a traffic characteristic exceeds the allowance it shows an abnormality. The current invention not only detects the real errors or failures of the network hardware and software, but also identifies other abnormalities due to non-hardware or non-software activities. These identifications are reported for different pre-defined coverage area as each operator requires based on different traffic characteristics.

### BRIEF DESCRIPTION OF THE DRAWINGS

FIG. 1 is a system structure of the current invention and interfaces with other wireless network resources.

FIG. 2 is a process flow of the current invention

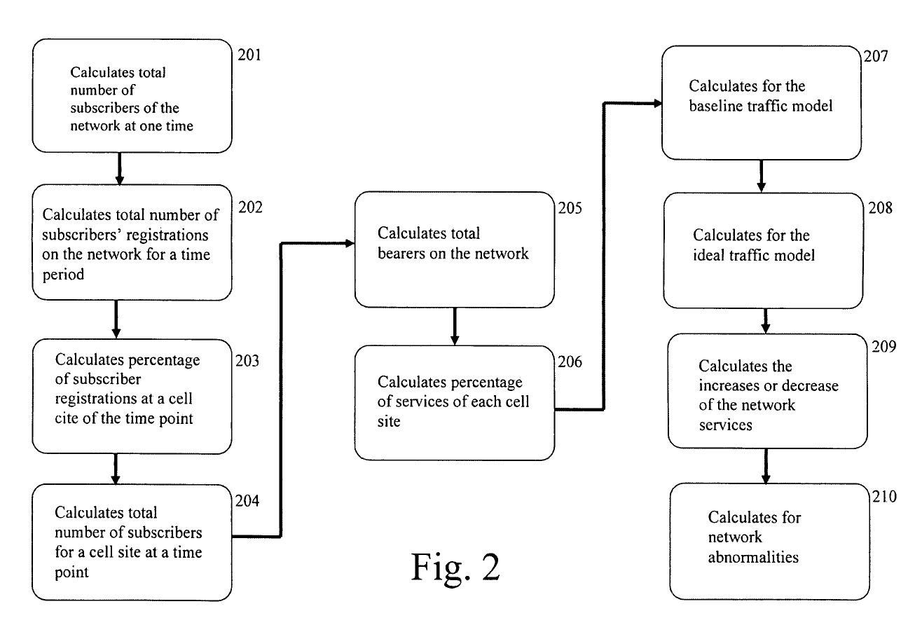

### DETAIL DESCRIPTIONS OF THE INVENTION

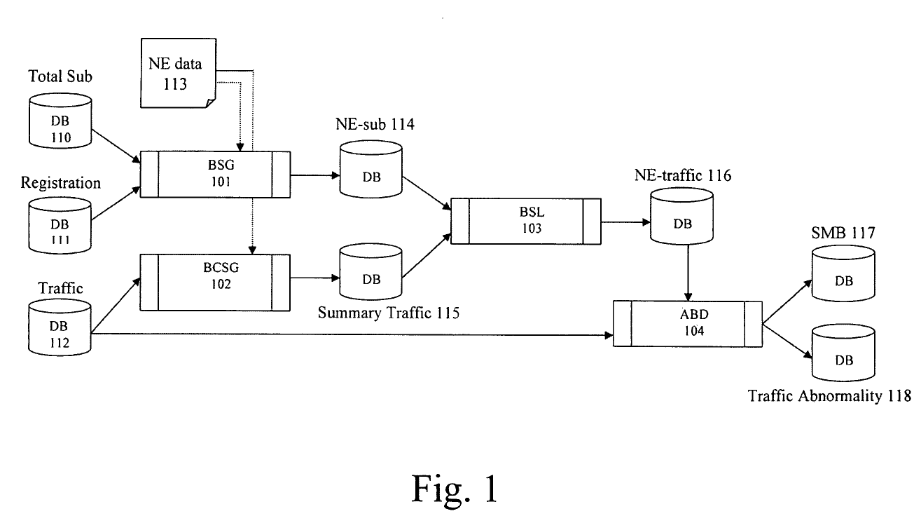

The present invention is a system for detecting network abnormalities and include four processors responsible for various tasks for the abnormality detections. The FIG. 1 shows a general system structure as well as its interfaces with the network resources. The four processors are,
1. Baseline Subscriber Generator (BSG)
2. Baseline Cell-Subscriber Generator (BCSG)
3. Baseliner (BSL)
4. Abnormality Detector (ABD)

The BSG 101 first collects the total number of subscribers of the network, and the number of subscribers registered at each cell site from the Network Management System or any system that provides such information depending on various network design, 110, 111, 12, 113. The total number of subscribers of the network at any time point is concluded, step 201, by the formula,

$$Total\_Sub ( t ) = {\sum }_{j = 1}^{m} Sub ( t , j )$$

where t=time point

j and m=number of subscriber nodes

For a GSM (Global System for Mobile Communications) system, the subscriber node is a HLR (Home Location Register), MSC (Mobile Switching Center), SGSN (Serving GPRS Support Node). For a NGN (Next generation Network) the subscriber node is IMS (IP Multimedia Subsystem). For a WCDMA (Wideband Code Division Multiple Access) system, the subscriber node is HLR, MSC, SGSN.

The number of subscribers' registrations of the network is concluded, step 202, by the formula,

$$Total\_Reg ( T ) = {\sum }_{i = 1}^{n} Reg ( T , i )$$

where T=time period

i and n=number of cell or NodeB (Base station for UMTS-3G technology) or RNC (Radio Network Controller)

After concluding with the total number of registrations of the network and the number of registrations at each cell site, the BSG 101 further calculates the percentage of subscriber registrations at a particular cell site of a particular time point, step 203, (Inact_Contribution). The time point that applies to the real traffic data collection is a predefined time point and can be determined by each operator for different exercises and analysis. The Inact_Contribution is concluded by formula,

$$Inact\_Contribution ( i ) = \frac{{\sum }_{T} Reg ( T , i )}{{\sum }_{T} Total\_Reg ( T )}$$

where T=time period

i=number of cell or NodeB or RNC

The inactive contribution of registration is based on an assumption that these registrations were caused by cyclic updates instead of power ON/OFF and mobility registrations. Therefore, in order to establish such a registration model, the traffic sample is collected between 1 o'clock and 5:59 o'clock in the morning.

The

$${\sum }_{T} Reg ( T , i )$$

represents a total registration of a particular Node within the time of 1 o'clock and 5:59 o'clock in the morning.

The

$${\sum }_{T} Total\_Reg ( T )$$

represents the total registrations of the whole network within the time of 1 o'clock and 5:59 o'clock in the morning

The total subscribers for a node at a time point is concluded by, step 204,

Initial_Sub(t, i)=Total_Sub(t)×Inact_contribution(i)

where t is a time point between 1:00 am and 5:59 am.

The assumption of this formula is that subscribers are in sleep and there are no mobile activities. This formula will be calculated for every node of the complete network.

A data base, Network-element Subscriber Database 114, is designed to maintain all results concluded by the BSG 101.

The BCSG 102 collects the total number of subscribers on the network, cell site's traffic information, and the network topology information from the Network Management System or any resource databases by different network equipment design. The network topology information includes the identity of each cell site's neighbor cells. All of the information collected by the BCSG 102 is known to the current network equipment. However, different network equipment operator may design and store this information at various network elements. A pre-configuration is required in order for the BCSG 102 to collect these required network data. Some of the data may not be in a standard format among all equipment providers according to the industry standards. However, the data formatting process is not within the scope of the current invention.

The BCSG 102, by using the collected data and the logic below, calculates each cell site's traffic baseline model.

The total bearers on the network is concluded by, step 205,

$$Traffic ( T , i ) = {\sum }_{x = 1}^{l} Bearer ( T , x , i )$$

where T is a time period
x is the number of different types of services (i.e., voice, SMS, WEB, etc.)
i is a node
1 is the number of bearer type

The percentage of services of each cell is concluded by, step 206,

$$Bearer\_Contribution ( T , x , i ) = \frac{Bearer ( T , x , i )}{Traffic ( T , i )}$$

where T is a time period
x is the number of different types of services (i.e., voice, SMS, WEB, etc.)
i is a node

A database, Summary Traffic Database 115, is designed to maintain the results from BCSG 102.

The BSL 103, after the BSG 101 and BCSG 102 create fundamental baseline information as described above, creates the baseline model for a complete network. This baseline model shows a statistical characteristic of the network that covers various cell areas. This baseline model is concluded by using the following logic.

The baseline traffic model is therefore concluded by, step 207,

$$General\_Model ( T , x ) = \frac{Total\_Bearer ( T , x )}{Total\_Sub ( T )}$$

where x is the number of different types of services (i.e., voice, SMS, WEB, etc.)

T is a time period of one (1) hour.

The final ideal traffic model is then concluded by, step 208,

Ideal_Model(T,x,i)=General_Model(T,x)×Inact_Contribution(i)

where x is the number of different types of services (i.e., voice, SMS, WEB, etc.)

i is a node

T is a time period of one (1) hour.

The baseline traffic model is created to be used for comparison purposes. Any traffic characteristic stays within the baseline model range is considered as normal traffic condition in terms of the specific timing and the coverage topology.

The baseline model may be adjusted as desired by sampling live traffic and subscriber data for various time point or geographic coverage area.

A database, Network-traffic Database 116, is designed to maintain the results from BSL 103.

The ABD 104 compares the live traffic data maintained in the traffic database 112 with the earlier created baseline model for different cell area. When the traffic characteristic falls beyond (either positive or negative) the baseline model for a specific time point, it is considered as an abnormality. A report of the abnormality is therefore generated for the operator for further investigation.

The ABD 104 calculates increases or decreases of the network services by, step 209,

Move_inout_Bearer(T,x,i)=Bearer(T,x,i)−Ideal_Model(T,x,i)

where T=time period of one (1) hour

Once the increase or decrease of the services are concluded, the abnormalities can therefore concluded by, step 210,

$$Move\_inout \_Sub ( T , i ) = {\sum }_{x = 1}^{l} \frac{Move\_inout \_Bearer ( T , x , i )}{General\_Model ( T , x )} \times Bearer\_Contribution ( T , x , i )$$

A database, Subscriber Mobility Behavior (SMB) Database 117, is designed to maintain the results from ABD 104 showing subscribers mobility behavior.

A database, Traffic Abnormality Database 118, is designed to maintain the abnormality information concluded from ABD 104,

The current invention is configured with complex hardware configurations to work with various network equipments in order to identify abnormalities. The modeling and statistical characterization processes are based on extensive logic. The descriptions as shown above are a detail disclosure how the current invention is implemented. Based on the implementation, various applications may be achieved by setting different sampling parameters of the logic.

1. A Network Subscriber Baseline Analyzer and Generator comprises,
a Baseline Subscriber Generator (BSG) wherein the BSG collects network subscriber data and calculates to conclude a total number of subscribers at a time point of the network,
the BSG further calculates a total number of subscriber registrations at the time point of the network; and
a Baseline Cell-Subscriber Generator (BCSG) wherein the BCSG collects the total number of subscribers, all cell site's traffic information, and network topology information, wherein the BCSG further calculates the total number of subscribers, the all cell site's traffic information, and the network topology information to conclude a cell site's traffic baseline model represented by a mathematical formula for each cell site on the network.

2. The Network Subscriber Baseline Analyzer and Generator of claim 1 further comprises,
a Baseliner (BSL) wherein the BSL collects and calculates the traffic baseline model of each cell site to conclude a traffic baseline model represented by a mathematical formula of the network; and
an Abnormality Detector (ABD) wherein the ABD collects network traffic data and compares the network traffic data with the each cell site's traffic baseline model to identify abnormalities.

3. The Network Subscriber Baseline Analyzer and Generator of claim 2, wherein
the BSG calculates to conclude the total number of subscribers at a time point of the network by formula
$$Total\_Sub ( t ) = {\sum }_{j = 1}^{m} Sub ( t , j )$$
where t=time point
j and m=number of subscriber nodes; and
the BSG calculates the total number of subscriber registrations at the time point of the network by formula
$$Total\_Reg ( T ) = {\sum }_{i = 1}^{n} Reg ( T , i )$$
where T=time period
i and n=number of cell or NodeB or RNC.

4. The Network Subscriber Baseline Analyzer and Generator of claim 3, wherein the BSG calculates percentage of subscriber registrations at a cell cite of the time point by formula
$$Inact\_Contribution ( i ) = \frac{{\sum }_{T} Reg ( T , i )}{{\sum }_{T} Total\_Reg ( T )}$$
where T=time period from 1 A.M. to 5:59 A.M.
i=number of cell or NodeB or RNC; and
the BSG calculates and concludes total number of subscribers for the cell site at the time point by formula
Initial_Sub(t,i)=Total_Sub(t)×Inact_contribution(i)
where t is a time point between 1:00 A.M. and 5:59 A.M.

5. The Network Subscriber Baseline Analyzer and Generator of claim 4, wherein the BCSG calculates and concludes total bearers on the network by formula
$$Traffic ( T , i ) = {\sum }_{x = 1}^{l} Bearer ( T , x , i )$$
where T is a time period
x is number of different types of services
i is a node
1 is the number of bearer type.

6. The Network Subscriber Baseline Analyzer and Generator of claim 5, wherein
the BCSG calculates and concludes percentage of services of the each cell site by formula
$$Bearer\_Contribution ( T , x , i ) = \frac{Bearer ( T , x , i )}{Traffic ( T , i )}$$
where T is a time period,
x is number of different types of services,
i is a node.

7. The Network Subscriber Baseline Analyzer and Generator of claim 6, wherein
the BSL calculates and concludes a baseline model of the network by formula
$$General\_Model ( T , x ) = \frac{Total\_Bearer ( T , x )}{Total\_Sub ( T )}$$
where x is number of different types of services,
T is a time period of one (1) hour.

8. The Network Subscriber Baseline Analyzer and Generator of claim 7, wherein
the BSL calculates and concludes final ideal traffic model of the network by formula
Ideal_Model(T,x,i)=General_Model(T,x)×Inact_Contribution(i)
where x is number of different types of services,
i is a node,
T is a time period of one (1) hour.

9. The Network Subscriber Baseline Analyzer and Generator of claim 8, wherein
the ABD calculates and concludes network services by formula
Move_inout_Bearer(T,x,i)=Bearer(T,x,i)−Ideal_Model(T,x,i)
where x is number of different types of services,
i is a node,
T is time period of one (1) hour.

10. The Network Subscriber Baseline Analyzer and Generator of claim 9, wherein
the ABD calculates and concludes abnormalities of the network by formula
$$Move\_inout \_Sub ( T , i ) = {\sum }_{x = 1}^{l} \frac{Move\_inout \_Bearer ( T , x , i )}{General\_Model ( T , x )} \times Bearer\_Contribution ( T , x , i )$$
where x is number of different types of services,
i is a node,
T is time period of one (1) hour.

11. A method of processing network traffic and subscriber data to conclude traffic baseline models and to detect network abnormalities comprises,
providing a Baseline Subscriber Generator (BSG) wherein the BSG collects network subscriber data and calculates to conclude a total number of subscribers at a time point of the network,
the BSG further calculates a total number of subscriber registrations at the time point of the network; and
providing a Baseline Cell-Subscriber Generator (BCSG) wherein the BCSG collects the total number of subscribers, all cell site's traffic information, and network topology information, wherein the BCSG further calculates the total number of subscribers, the all cell site's traffic information, and the network topology information to conclude a cell site's traffic baseline model represented by a mathematical formula for each cell site on the network.

12. The method of processing network traffic and subscriber data to conclude traffic baseline models and to detect network abnormalities of claim 11 further comprises,
providing a Baseliner (BSL) wherein the BSL collects and calculates the traffic baseline model of each cell site to conclude a traffic baseline model represented by a mathematical formula of the network; and
providing an Abnormality Detector (ABD) wherein the ABD collects network traffic data and compares the network traffic data with the each cell site's traffic baseline model to identify abnormalities.

13. The method of processing network traffic and subscriber data to conclude traffic baseline models and to detect network abnormalities of claim 12 further comprises,
the BSG calculates to conclude the total number of subscribers at a time point of the network by formula
$$Total\_Sub ( t ) = {\sum }_{j = 1}^{m} Sub ( t , j )$$
where t is a time point,
j and m are number of subscriber nodes; and
the BSG calculates the total number of subscriber registrations at the time point of the network by formula
$$Total\_Reg ( T ) = {\sum }_{i = 1}^{n} Reg ( T , i )$$
where T is a time period,
i and n are number of cell or NodeB or RNC.

14. The method of processing network traffic and subscriber data to conclude traffic baseline models and to detect network abnormalities of claim 13 further comprises,
the BSG calculates percentage of subscriber registrations at a cell cite of the time point by formula
$$Inact\_Contribution ( i ) = \frac{{\sum }_{T} Reg ( T , i )}{{\sum }_{T} Total\_Reg ( T )}$$
where T is time period from 1 A.M. to 5:59 A.M.
i is number of cell or NodeB or RNC; and
the BSG calculates and concludes total number of subscribers for the cell site at the time point by formula
Initial_Sub(t,i)=Total_Sub(t)×Inact_contribution (i)
where t is a time point between 1:00 A.M. and 5:59 A.M.

15. The method of processing network traffic and subscriber data to conclude traffic baseline models and to detect network abnormalities of claim 14 further comprises,
the BCSG calculates and concludes total bearers on the network by formula
$$Traffic ( T , i ) = {\sum }_{x = 1}^{l} Bearer ( T , x , i )$$
where T is a time period,
x is number of different types of services,
i is a node,
1 is the number of bearer type.

16. The method of processing network traffic and subscriber data to conclude traffic baseline models and to detect network abnormalities of claim 15 further comprises,
the BCSG calculates and concludes percentage of services of the each cell site by formula
$$Bearer\_Contribution ( T , x , i ) = \frac{Bearer ( T , x , i )}{Traffic ( T , i )}$$
where T is a time period,
x is number of different types of services,
i is a node.

17. The method of processing network traffic and subscriber data to conclude traffic baseline models and to detect network abnormalities of claim 16 further comprises,
the BSL calculates and concludes a baseline model of the network by formula
$$General\_Model ( T , x ) = \frac{Total\_Bearer ( T , x )}{Total\_Sub ( T )}$$
where x is number of different types of services,
T is a time period of one (1) hour.

18. The method of processing network traffic and subscriber data to conclude traffic baseline models and to detect network abnormalities of claim 17 further comprises,
the BSL calculates and concludes final ideal traffic model of the network by formula
Ideal_Model(T,x,i)=General_Model(T,x)×Inact_Contribution(i)
where x is number of different types of services,
i is a node,
T is a time period of one (1) hour.

19. The method of processing network traffic and subscriber data to conclude traffic baseline models and to detect network abnormalities of claim 18 further comprises,
the ABD calculates and concludes network services by formula
Move_inout_Bearer(T,x,i)=Bearer(T,x,i)−Ideal_Model(T,x,i)
where x is number of different types of services,
i is a node,
T is time period of one (1) hour.

20. The method of processing network traffic and subscriber data to conclude traffic baseline models and to detect network abnormalities of claim 19 further comprises,
the ABD calculates and concludes abnormalities of the network by formula
$$Move\_inout \_Sub ( T , i ) = {\sum }_{x = 1}^{l} \frac{Move\_inout \_Bearer ( T , x , i )}{General\_Model ( T , x )} \times Bearer\_Contribution ( T , x , i )$$
where x is number of different types of services,
i is a node,
T is time period of one (1) hour.
